(19) United States
(12) Patent Application Publication
(10) Pub. No.: US 2004/0265190 A1
(43) Pub. Date: Dec. 30, 2004

(54) Microcomponent

(76) Inventors: Guido Pieper, Darmstadt (DE); Michael Schmelz, Riedstadt (DE); Hanns Wurziger, Darmstadt (DE); Norbert Schwesinger, Eching (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/490,255

(22) PCT Filed: Aug. 30, 2002
(86) PCT No.: PCT/EP02/09718

(30) Foreign Application Priority Data
Sep. 21, 2001 (DE) 10146545.9

(51) Int. Cl. B01J 19/00

(52) U.S. Cl. 422/130; 422/99

(57) ABSTRACT

A microcomponent (1) for carrying out chemical reactions has an electric heating element, which is arranged directly on the surface of the microcomponent (1). The electric heating element can have, for example, a printed conductor track (3) applied to the surface of the microcomponent (1). The heating of the microcomponent (1) can be measured continuously using a temperature sensor essentially consisting of a resistance thermometer (4). The microcomponent (1) and the electric heating element can be produced by means of semiconductor manufacturing methods. A plurality of microcomponents (1) can be used arranged alongside one another for carrying out a complex reaction process.

The invention relates to a microcomponent for carrying out chemical reactions.

In many areas of the chemical, pharmaceutical and biological industries, reaction processes carried out for research or production purposes are being constantly and increasingly miniaturised. This enables, for example, the requisite amounts of reagents and substances and the reaction time necessary for carrying out the process to be reduced. Individual microcomponents which enable the process to be carried out with dimensions in the micro region are increasingly being employed.

Reaction components having such small dimensions cannot be produced simply by reducing the size of known tried and tested designs. Owing to the extremely small amounts of substances involved, completely different flow and reaction properties, inter alia, often arise. Besides novel production processes for the individual microcomponents, their design therefore also has to be matched to the properties prevailing in the micro region.

In particular in research and development activities, it is advantageous to employ microcomponents which facilitate a reaction process which proceeds as quickly as possible, for which only small amounts of substance are required. This is favourable, in particular, on use of substances which are hazardous or a health risk and simplifies carrying out the process for highly endothermic or exothermic reactions. In combination with a significantly reduced space requirement, test reactions can be carried out simultaneously in large number for research purposes. In this way, it is possible significantly to reduce the development times for new products or chemical processes with relatively low financial cost.

Individual microcomponents which are used for carrying out miniaturised reaction processes have already been disclosed. Complete reaction processes can be carried out on a miniaturised scale by connecting separate microcomponents, such as pumps, mixers, hold-up elements, reactors and heat exchangers in series. Whereas for individual reaction steps, such as, for example, the mixing of a plurality of substances, highly efficient micromixers have been developed at great effort, control of the temperature which determines a reaction process is carried out in a conventional manner by means of heating baths or heat exchangers. If it is intended that a pre-specified temperature is to be kept as constant as possible for some or a plurality of process steps, the associated microcomponents are introduced into a heating bath. The heating baths or cryostats usually used have an unnecessarily large volume for microcomponents. Temperature changes of the heating bath, as are a prerequisite, for example, for an experimental series of identical reactions at different pre-specified reaction temperatures, require a corresponding time and may become the determining time factor of an experimental series of this type.

Many reaction processes proceed more quickly and/or effectively at elevated temperature. The heating baths usually used can only be operated up to a heating-bath temperature of about 80° C. by means of simple media. On use of water as heating medium, it is very difficult to achieve temperatures above 100° C. The maximum possible temperature range cannot be significantly widened through the use of specific additives or an oil.

The object of the invention is therefore to ensure effective heating of individual microcomponents using the simplest possible means. It should be possible for the temperature pre-specified for a reaction step to be changed simply and quickly in order to facilitate rapid performance of extensive experimental series.

This object is achieved in accordance with the invention in that an electric heating element is arranged on the surface of the microcomponent. The dimensions of the individual microcomponents are sufficiently small for an electric heating element matched to the microcomponent to ensure rapid and sufficiently uniform heating of the microcomponent. The electric heating element can be attached to the surface of the microcomponent using extremely simple means. In this way, design changes in the interior of the microcomponent are unnecessary.

Since the microcomponent can be heated by the electric heating element, the use of a heating bath for heating is superfluous. The structure and course of a reaction process composed of microcomponents of this type are no longer bound by the spatial characteristics of the heating bath. The microcomponent can be heated in an extremely short time by means of the electric heating element, meaning that the waiting times necessary for controlled heating of the heating bath do not arise.

Reactions with liquid substances which flow through one or more microcomponents during the reaction are frequently carried out. In these, both the microcomponents and the requisite feed and discharge lines and, in particular, the connecting elements must be completely leak-proof in order to ensure that the process proceeds without interruption. Whereas liquids escaping at a leaky point are virtually impossible to detect in a heating bath, a microcomponent with electric heating used in the dry state enables rapid detection and location of leaks. This considerably reduces the risks on use of substances which are hazardous or a health risk and at the same time increases the reliability of the reactions carried out.

The maximum possible heating temperature of an electric heating element is not restricted to a region up to about 100° C., which means that reactions can also be carried out at significantly higher temperatures. In this way, the temperature range accessible for experiments is considerably widened for various reaction steps, giving rise to improved research conditions and completely new applications.

It is preferably provided that the electric heating element has a printed conductor track applied to the surface of the microcomponent. The microcomponent surface to be heated can be designed without difficulties as a flat surface. Simple and inexpensive processes for the production of printed circuits of virtually any shape are known. Printed conductor tracks, for example in the shape of a heating coil, can be applied in a strongly adherent manner to the flat surface of the microcomponent. Through direct contact of the electric conductor track with the surface of the microcomponent, best-possible heat transport into the microcomponent is ensured. The shape and dimension, which can, for example, be changed in sections, of the printed conductor track enable heating of the microcomponent which is extremely uniform or different from region to region.

The printed conductor track needs virtually no additional space, and the requisite electrical connections can be given dimensions which are virtually as small as desired. Conductor tracks with characteristic dimensions in the micron region can be produced using manufacturing techniques which are already known, which means that an electric heating element of this type does not represent a restriction to further miniaturisation of the microcomponents.

According to a refinement of the inventive idea, it is provided that the electric heating element is a heating foil. Microcomponents already used can be rendered electrically heatable by means of a heating foil adhesively bonded to the microcomponent. In this way, virtually any desired microcomponent can be provided with an electric heating element. An electric heating foil is inexpensive and can also be attached to uneven surfaces of a microcomponent. Ready-made components for temperature control of a heating foil, which can be matched to the particular requirements of laboratory or production operation using simple means, already exist.

It is preferably provided that a temperature sensor is arranged on the surface of the microcomponent. A temperature sensor allows the surface temperature of the microcomponent to be measured continuously. In this way, regulated heating can be achieved. In particular, temperature changes caused by highly endothermic or exothermic reactions can be taken into account even during the reaction process and control of the electric heating element matched thereto.

It is particularly advantageously provided that the temperature sensor essentially consists of a resistance thermometer. Resistance thermometers have relatively high accuracy of the temperature measurement over a large temperature range. Owing to their low heat capacity, they have virtually no evident effect on the heating of a microcomponent, but react quickly and precisely to temperature changes.

According to a refinement of the inventive idea, it is provided that the connections of the electric heating element are arranged in the region of a side edge of the microcomponent. The microcomponent can, for example, be inserted into a known connection carrier for plate-shaped microcomponents (DE 198 54 096 A1). Owing to the connections arranged in the region of a side edge, contacting of the electric heating element, which is necessary for operation, can take place via contact surfaces at the side edge inserted into the connection carrier.

It is particularly advantageously provided that the connections of the heating element have electrical contact surfaces arranged on a side face. The contacting of the heating element is then carried out in a space-saving manner via the contact surfaces on a front face of the microcomponent. This simplifies the design complexity of connection carriers, since a plurality of microcomponents can be arranged directly alongside one another and the contacting of the respective heating elements takes place on the connection carrier upper side facing the microcomponents via contact surfaces arranged alongside one another in a manner matched thereto.

The invention also relates to a process for the production of a microcomponent for carrying out chemical reactions, in which the microcomponent and the electric heating element are produced by means of semiconductor manufacturing methods. The microcomponent here is made from microstructurable material, for example silicon or glass. A microcomponent made from silicon has very favourable thermal conduction properties.

For the production and machining of the microcomponent, recourse can be made to the processes and experience from semiconductor manufacture, for example chip production. Using the same methods, the electric heating element, for example in the form of a printed conductor track, can be arranged on the surface of the microcomponent. The amount of additional work and materials necessary for the electric heating element is extremely small, meaning that the electric heating element hardly increases the production costs for the microcomponent at all.

The invention likewise relates to an arrangement of a plurality of microcomponents on a common base plate. In this way, a complex reaction sequence with, for example, a plurality of mixers and different hold-up components can be achieved very simply.

It is advantageously provided that a separate holder arranged on the common base plate is assigned to each microcomponent. Each holder has separate connections for the feed and discharge of the chemical substances involved and electrical contacts for the heating element of the microcomponent. This enables very flexible specification of the reaction conditions, which is also variable over the entire course of the process, which is achieved on the common base plate, and varies for the individual reaction steps.

According to a refinement of the inventive idea, it is provided that the associated connections of the adjacent holders have permanently attached connecting lines. If individual microcomponents are exchanged, there is then no need to disconnect and reconnect the associated connecting lines. Changes in the reaction sequence can therefore be carried out quickly and reliably, and different reactions with the individual components can thus constantly be implemented and carried out in a short time.

It is preferably provided that the base plate has a common holder for a plurality of microcomponents. The very compact arrangement enables a common reaction temperature for all microcomponents to be pre-specified quickly.

Further advantageous refinements of the inventive idea are the subject-matter of further sub-claims.

A working example of the invention is explained in greater detail below and is shown in the drawing, in which:

FIG. 1 shows a view of a microcomponent with an electric heating element and a temperature sensor,

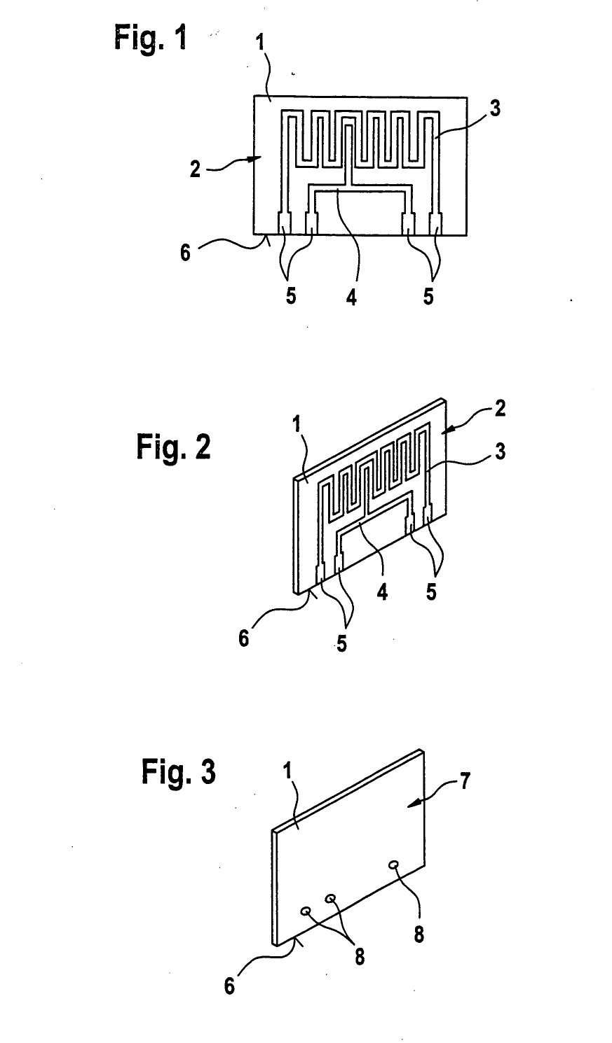

FIG. 2 shows a further view of the microcomponent shown in FIG. 1,

FIG. 3 shows a view of the back of the microcomponent shown in FIGS. 1 and 2,

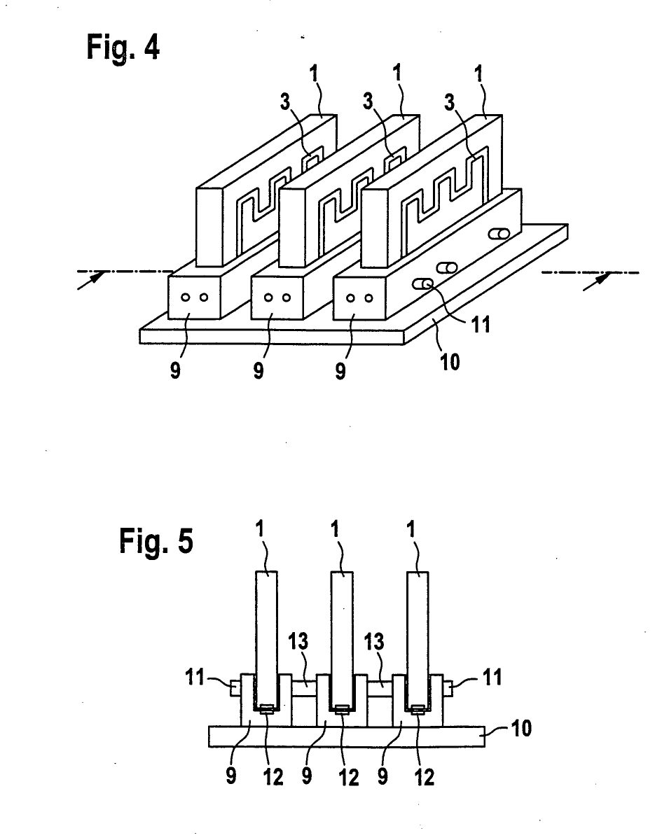

FIG. 4 shows a diagrammatic view of a plurality of microcomponents arranged one after the other in separate holders on a common base plate,

FIG. 5 shows a section along line VI-VI of the arrangement shown in FIG. 4,

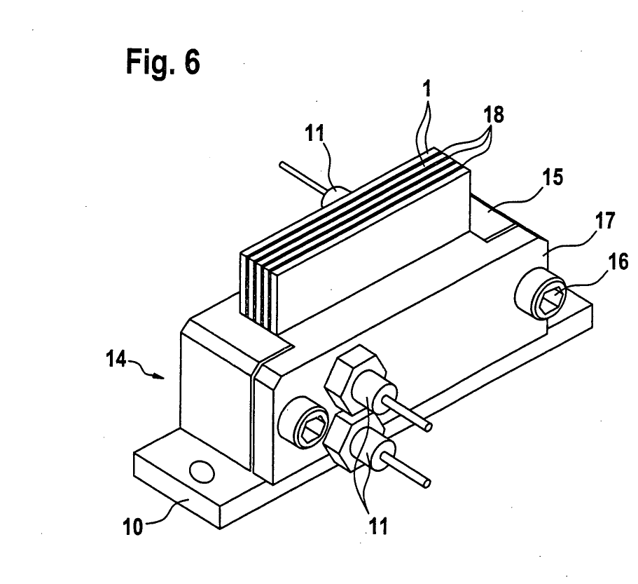

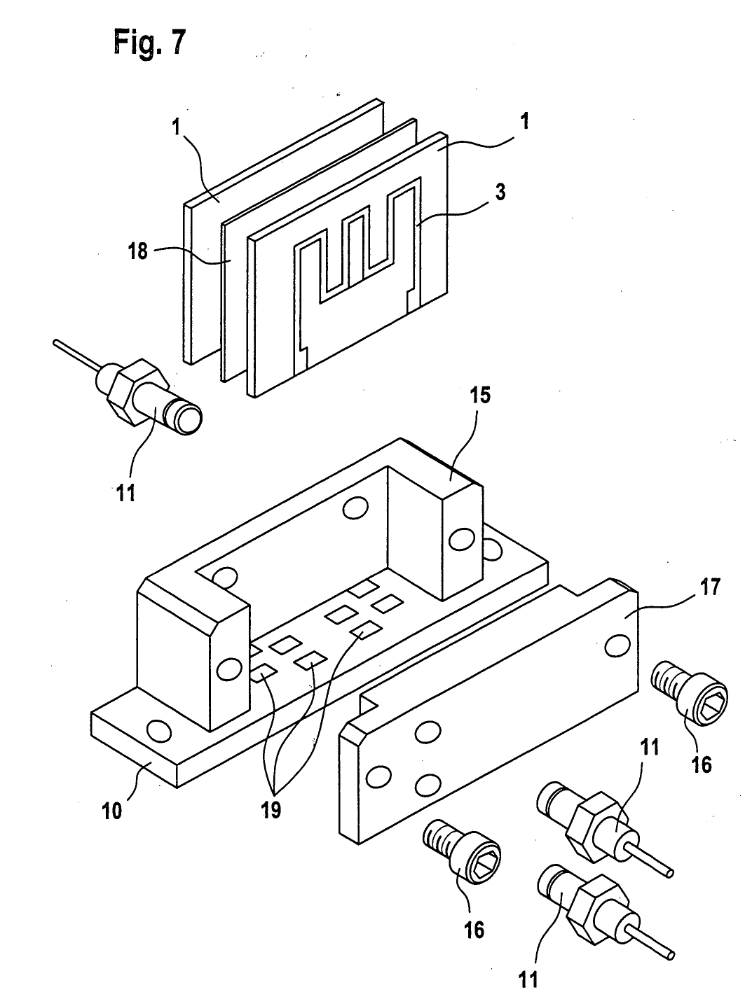

FIG. 6 shows a view of a plurality of microcomponents accommodated in a common holder, and

FIG. 7 shows an exploded view of the arrangement shown in FIG. 6.

FIGS. 1-3 show a microcomponent 1 in the form of a thin, rectangular plate. A conductor track 3 is arranged as electric heating element on the front 2 of microcomponent 1. The conductor track 3 has an essentially meander-shaped course over a large region of the front 2 of microcomponent 1. In this way, a high, uniform heating action by conductor track 3 is achieved.

A resistance thermometer 4, which is operated as a temperature sensor, is arranged in the region of the meander-shaped course of the conductor track. Both the conductor track 3 and the resistance thermometer 4 have electrical contacts 5 in the region of the underside 6 of microcomponent 1. The conductor track 3 as electric heating element can be controlled via these electrical contacts 5. In the same way, the resistance thermometer 4 can readily be operated as a temperature sensor, with the measured signals from the resistance thermometer 4 being used to regulate the heating action of the conductor track 3.

Both the conductor track 3 and the resistance thermometer 4 can be produced essentially as printed conductor tracks by means of known semiconductor manufacturing methods. To this end, for example, a metal layer is applied to the surface of the microcomponent 1, the metal layer is coated with a photoresist, the photoresist is then exposed in the region of the course of the conductor track in accordance with the desired design, and the metal layer is removed again in unexposed regions by subsequent etching.

FIG. 3 shows the back 7 of microcomponent 1, which has three apertures 8 in the vicinity of the underside 6. These apertures 8 serve for connection of microcomponent 1 to feed and discharge lines, enabling the substances required for a reaction step to be fed to microcomponent 1 and discharged therefrom.

FIGS. 4 and 5 show a plurality of separate holders 9, in each of which one of the three microcomponents 1 shown is accommodated alongside one another on a common base plate 10. Each of the outer holders 9 has connections 11 for the feed and discharge of the substances involved. These line connections 11 can be in the form of standardised and sufficiently stable connection devices, enabling simple handling and frequent change of the connected lines. Each holder 9 has electrical connections 12 for the heating element of microcomponent 1 accommodated therein. These are in the form of contact surfaces mounted in a gently sprung manner.

The connecting lines 13 are permanently installed between the adjacent holders, thus guaranteeing their freedom from leaks over a long operating period. Given corresponding design of the connecting lines 13 between the individual microcomponents 1, a complex reaction process composed of a plurality of individual steps can be implemented in this way. This results in further miniaturisation, since the individual microcomponents 1 are arranged in a space-saving, compact manner and complex connecting elements between individual microcomponents 1 are unnecessary. Nevertheless, the individual microcomponents 1 can be brought separately to a particular pre-specified temperature by means of the respective heating elements. The temperature prevailing in each microcomponent 1 can be measured via temperature sensors, thus enabling regulated temperature control.

FIGS. 6 and 7 show a common holder 14 for a plurality of microcomponents 1 which is mounted on a base plate 10. The holder 14 consists of a U-shaped accommodation device 15, in which a plurality of microcomponents 1 are arranged by means of a side part 17, which can be attached by means of screws 16. The adjacent microcomponents 1 are separated and sealed-off from one another by thin layers 18 of chemically resistant plastic, for example a PTFE film, in between. The holder has a plurality of connections 11 for the feed and discharge of the chemical substances used.

In the case of a common holder for a plurality of microcomponents, it is possible for the holder to have separate electrical connections for control of the individual heating elements of each microcomponent. On the side of the base plate 10 facing the microcomponents 1, electrical connections 19 for connection to the heating element of the associated microcomponent 1 are arranged as separate contact surfaces for each microcomponent 1. Owing to the very compact arrangement, the microcomponents 1 can be heated quickly and reliably to a desired common reaction temperature. Since there is no need for in each case individual microcomponents 1 or the entire holder 14 fitted with a plurality of microcomponents 1 to be introduced into a heating bath, entire reaction processes can in this way be carried out rapidly using extremely simple means, even with in each case different pre-specified temperatures, which are the same for the reaction process as a whole.

1. Microcomponent for carrying out chemical reactions, characterised in that an electric heating element is arranged on the surface of the microcomponent (1).

2. Microcomponent according to claim 1, characterised in that the electric heating element is essentially an electrical conductor.

3. Microcomponent according to claim 1, characterised in that the electric heating element has a printed conductor track (3) applied to the surface of the microcomponent (1).

4. Microcomponent according to claim 1, characterised in that the heating element is a heating foil.

5. Microcomponent according to claim 1, characterised in that a temperature sensor is arranged on the surface of the microcomponent (1).

6. Microcomponent according to claim 5, characterised in that the temperature sensor essentially consists of a resistance thermometer (4).

7. Microcomponent according to claim 1, characterised in that the connections of the electric heating element are arranged in the region of a side edge of the microcomponent.

8. Microcomponent according to claim 7, characterised in that the connections of the heating element have electrical contact surfaces arranged on a side face.

9. Process for the production of a microcomponent according to claim 1, characterised in that the microcomponent (1) and the electric heating element are produced by means of semiconductor manufacturing methods.

10. Process according to claim 9, characterised in that a metal layer is applied to the surface of the microcomponent (1), the metal layer is coated with a photoresist, the photoresist is exposed in the region of the course of the conductor track, and the metal layer is subsequently removed in unexposed regions by etching.

11. Arrangement of a plurality of microcomponents according to claim 1 on a common base plate (10).

12. Arrangement according to claim 11, characterised in that a separate holder (9) arranged on the common base plate (10) is assigned to each microcomponent (1).

13. Arrangement according to claim 12, characterised in that the associated connections of the adjacent holders (9) have permanently attached connecting lines (13).

14. Arrangement according to claim 11, characterised in that the base plate (10) has a common holder (14) for a plurality of microcomponents (1).

15. Arrangement according to claim 14, characterised in that the holder (14) has separate electrical connections (19) for control of the individual heating elements of each microcomponent (1).
